(19) United States
(12) Patent Application Publication
(10) Pub. No.: US 2014/0225853 A1
(43) Pub. Date: Aug. 14, 2014

(54) INFORMATION PROCESSING DEVICE, INFORMATION PROCESSING METHOD, AND PROGRAM

(71) Applicant: SONY CORPORATION, Minato-Ku (JP)

(72) Inventor: Daisuke Yamamoto, Tokyo (JP)

(73) Assignee: SONY CORPORATION, Minato-Ku (JP)

(21) Appl. No.: 14/346,146

(22) PCT Filed: Oct. 25, 2012
(86) PCT No.: PCT/JP2012/006839

§ 371 Date: Mar. 20, 2014

(30) Foreign Application Priority Data
Nov. 29, 2011 (JP) 2011-260434

(51) Int. Cl. G06F 3/041

(52) U.S. Cl. CPC G06F 3/041
USPC 345/173

(57) ABSTRACT

An apparatus (10) includes a proximity detection information receiving unit (11) and a controller (14). The proximity detection information receiving unit (11) is configured to receive an indication that an object (U1) is in proximity with or touching a surface. The controller (14) is configured to perform a proximity process when the object is in proximity with the surface, end the proximity process when the object is no longer in proximity with the surface, and perform a touch process different than the proximity process when the object is touching the surface.

### TECHNICAL FIELD

The present disclosure relates to an information processing device, an information processing method, and a program encoded on a non-transitory computer readable medium.

### BACKGROUND ART

Various techniques allowing users to conveniently carry out operations have been proposed. For example, according to the technique disclosed in Patent Literature 1, a user may carry out a selection operation selecting one selection candidate image from a plurality of selection candidate images using a jog dial.

### CITATION LIST

### Patent Literature

PTL 1: JP 2006-140865A

### SUMMARY

### Technical Problem

However, in the technique disclosed in Patent Literature 1, it is necessary for the user to operate a cancellation button separate from the jog dial in order to cancel the selection operation carried out by the user. For this reason, a technique allowing the user to readily carry out the cancellation operation has been sought.

### Solution to Problem

In one embodiment, the present invention includes an apparatus includes a proximity detection information receiving unit and a controller. The proximity detection information receiving unit is configured to receive an indication that an object is in proximity with or touching a surface. The controller is configured to perform a proximity process when the object is in proximity with the surface, end the proximity process when the object is no longer in proximity with the surface, and perform a touch process different than the proximity process when the object is touching the surface.

### Advantageous Effects of Invention

According to the present disclosure described above, the user can simply move an operation medium away from a proximity operation unit to cancel a proximity operation, and can thus readily carry out a cancellation operation.

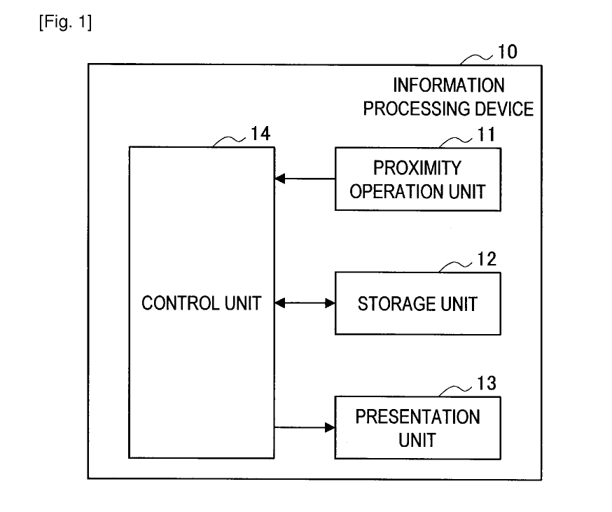

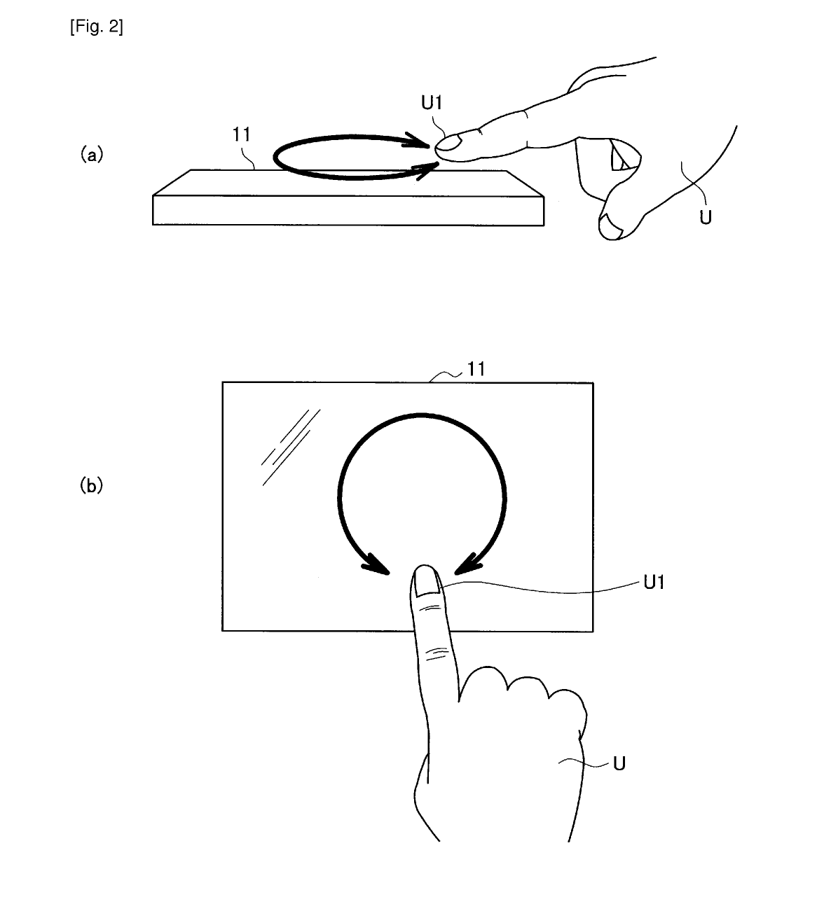

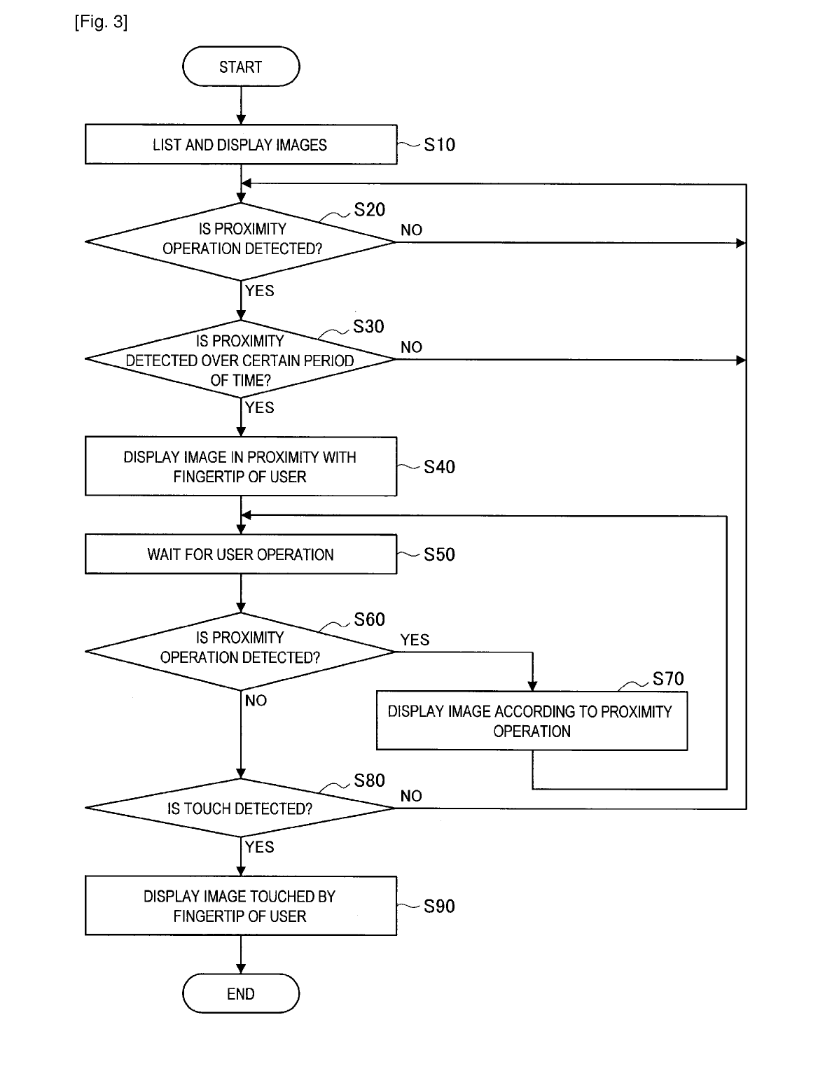

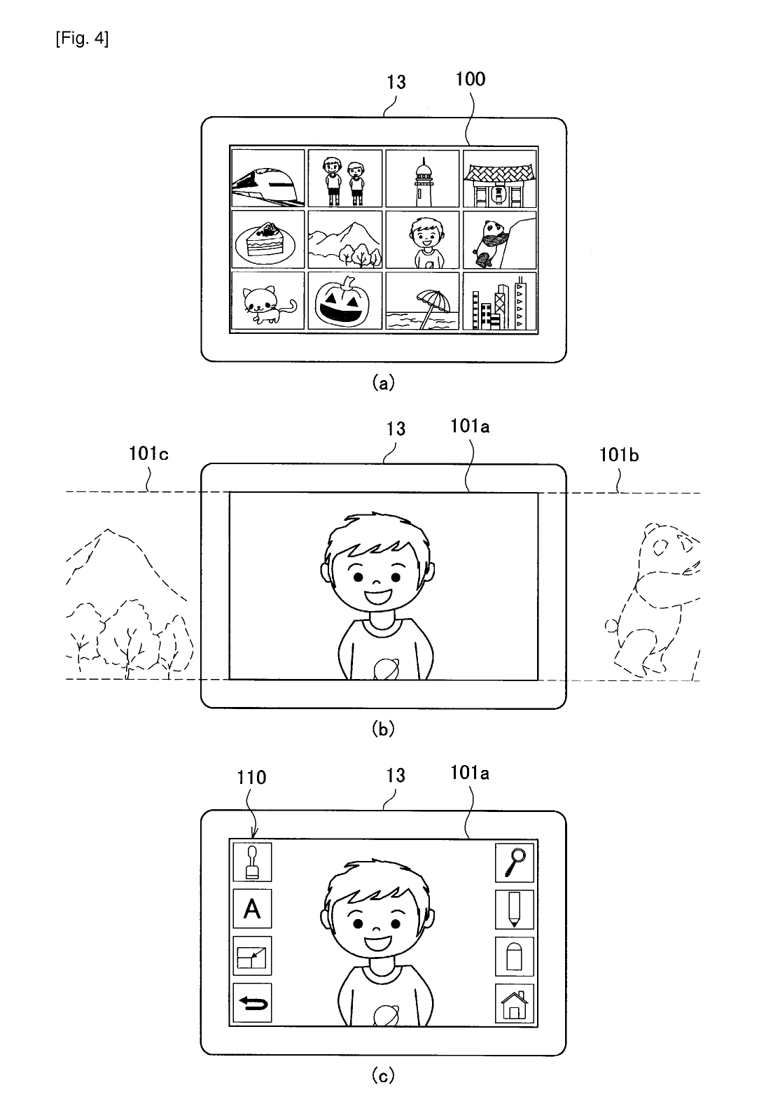

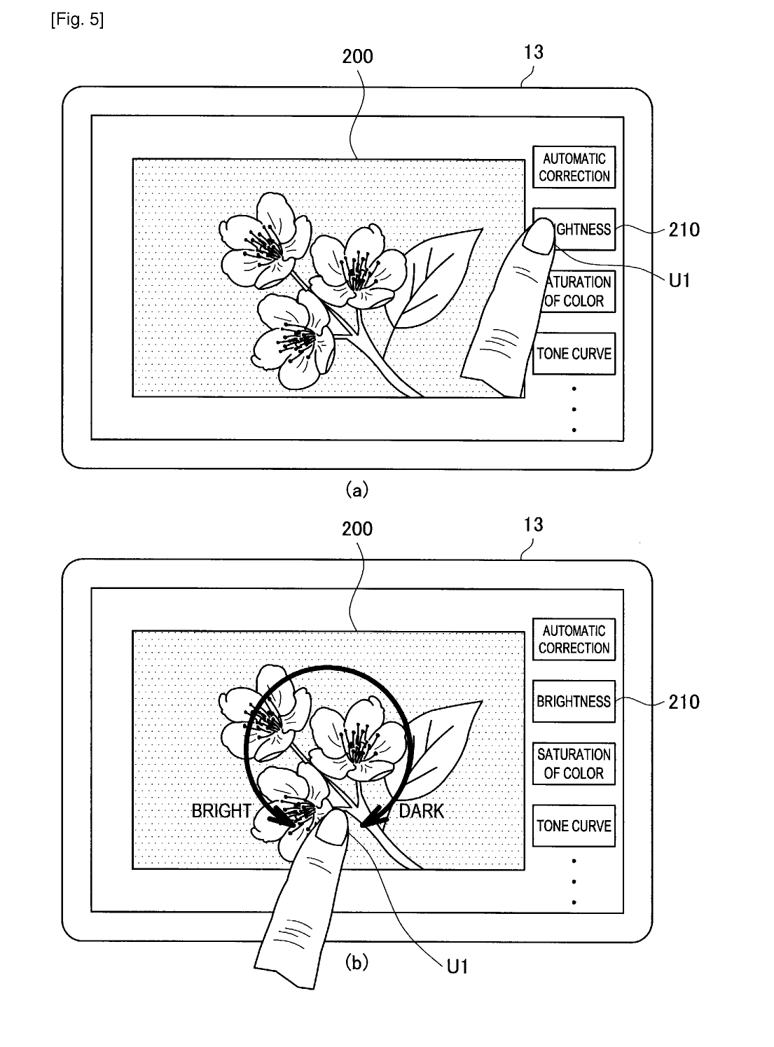

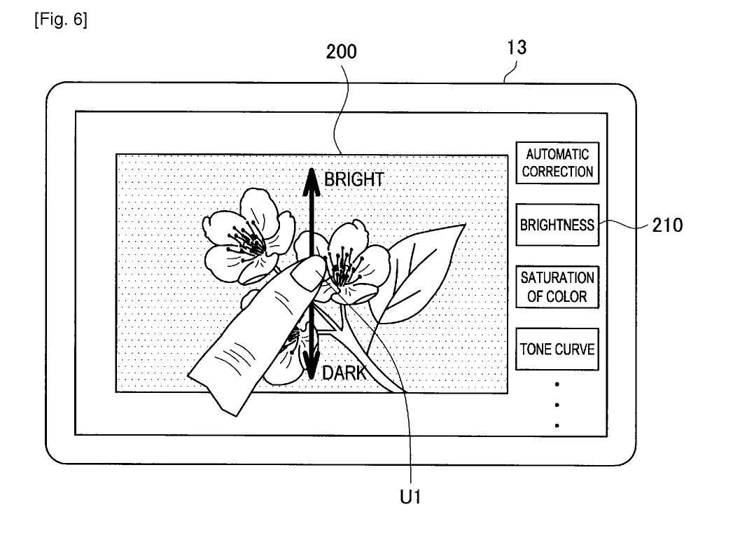

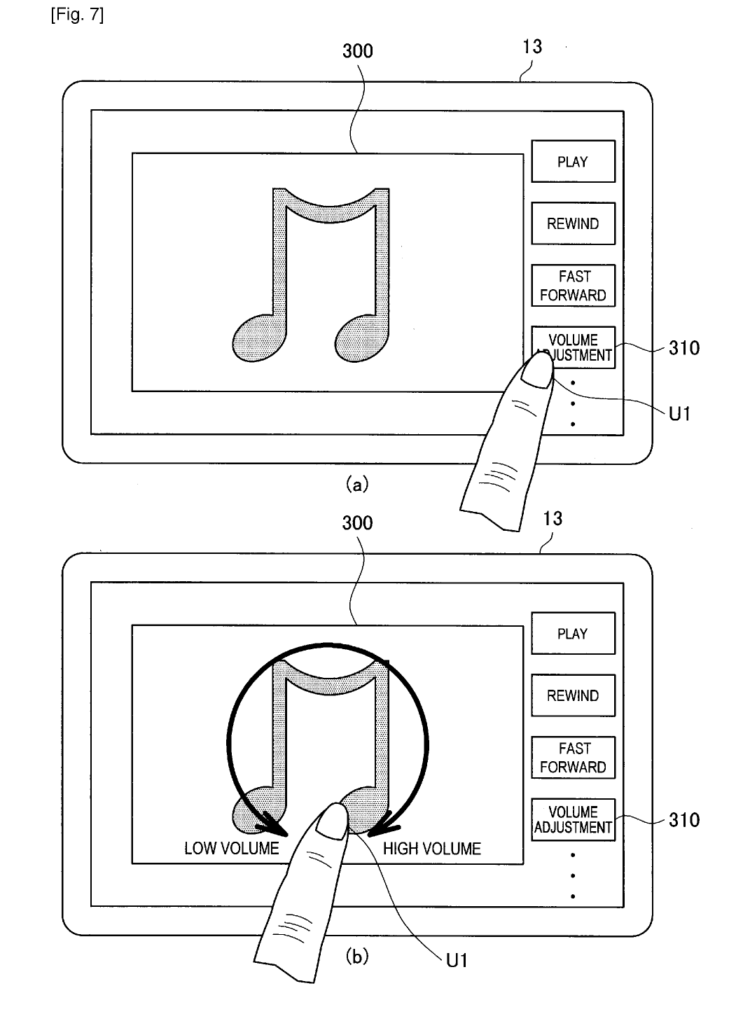

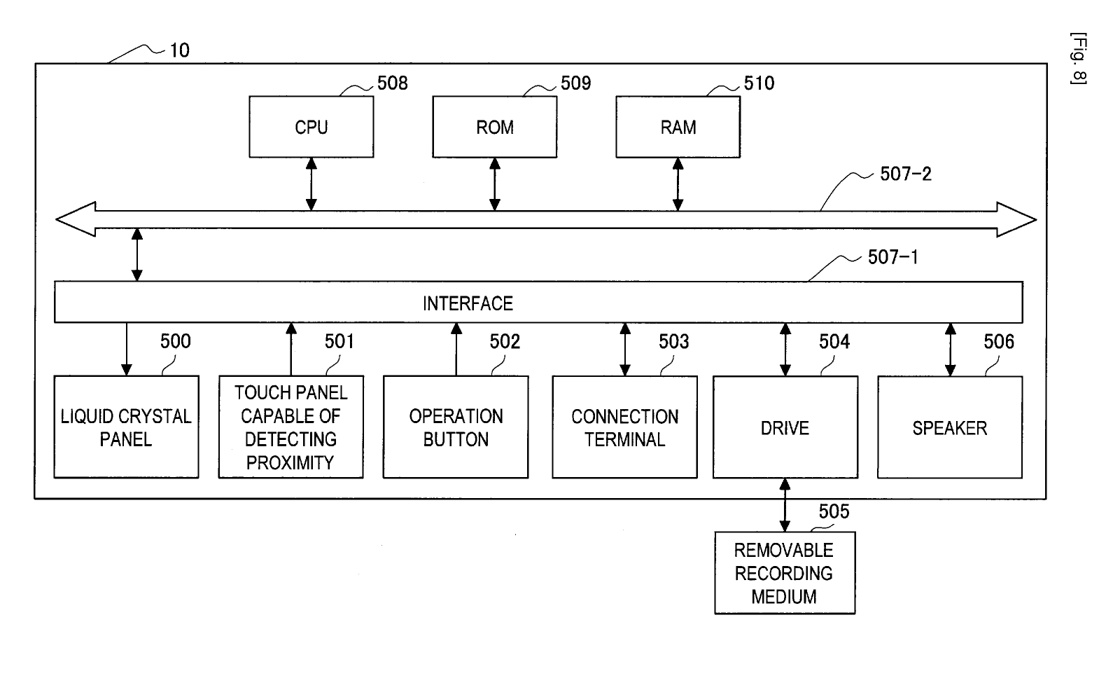

### BRIEF DESCRIPTION OF DRAWINGS

[FIG. 1]FIG. 1 is a block diagram illustrating an information processing device in accordance with an embodiment of the present disclosure;

[FIG. 2]FIG. 2 is a diagram illustrating an example of a proximity operation;

[FIG. 3]FIG. 3 is a flowchart illustrating a process sequence of an information processing device;

[FIG. 4]FIG. 4 is a diagram illustrating a transition state of images displayed in a display unit;

[FIG. 5]FIG. 5 is a diagram illustrating an example image displayed in a first modification example of the present disclosure;

[FIG. 6]FIG. 6 is a diagram illustrating an example image displayed in the first modification example of the present disclosure;

[FIG. 7]FIG. 7 is a diagram illustrating an example image displayed in a second modification of the present disclosure; and

[FIG. 8]FIG. 8 is a diagram illustrating an example of a hardware configuration of the information processing device.

### DESCRIPTION OF EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, the description is made in the following order.

1. Configuration of information processing device

2. Process sequence of information processing device

3. First modification example

4. Second modification example

### 1. Configuration of Information Processing Device

First, the configuration of the information processing device 10 will be described with reference to FIGS. 1 and 8. As shown in FIG. 1, the information processing device 10 includes a proximity operation unit 11, a storage unit 12, a presentation unit 13, and a control unit 14. The information processing device 10 is realized by the hardware configuration shown in FIG. 8. That is, the information processing device 10 includes a liquid crystal panel 500, a touch panel 501 capable of detecting the proximity, an operation button 502, a connection terminal 503, a drive 504, a speaker 506, an interface 507-1, a communication bus 507-2, a CPU 508, a ROM 509, and a RAM 510 as the hardware configuration.

The proximity operation unit 11 is realized by the touch panel 501 capable of detecting the proximity. The storage unit 12 is realized by the ROM 509 and the RAM 510. The presentation unit 13 is realized by the liquid crystal panel 500 and the speaker 506. The control unit 14 is realized by causing the CPU 508 to read and execute a program stored in the ROM 509. That is, the program for causing the information processing device 10 to act as the control unit 14 is stored in the ROM 509.

The operation button 502 is a button operated by the user, and the connection terminal 503 is a portion to which a cable connecting the information processing device 10 to other information processing devices is connected. The drive 504 is a portion on or from which a removable storage medium 505 is mounted or dismounted. The interface 507-1 and the communication bus 508 connect components of the information processing device 10 to each other.

The proximity operation unit 11 detects an input operation using an approaching operation medium (e.g., a fingertip of the user, a touch pen, and so forth) as a proximity operation. In addition, such a proximity operation is also referred to as a gesture operation. The proximity operation unit 11 is disposed on a portion at which the image is displayed on the presentation unit 13, that is, on the surface of the liquid crystal panel 500. When the proximity operation is detected, the proximity operation unit 11 outputs proximity operation information regarding contents of the proximity operation to the control unit 14.

The proximity operation, for example, is an operation causing the operation medium to move or stop while the operation medium is in proximity with the proximity operation unit 11. In addition, the state in which the operation medium is in proximity with the proximity operation unit 11, for example, means the state in which an interval between the operation medium and the proximity operation unit 11 is greater than 0 cm and equal to or smaller than a predetermined proximity threshold value (e.g., 2 to 3 cm). In addition, the proximity operation is classified as a rotational operation, a stop operation, or another operation in the present embodiment.

The rotational operation is an operation by which the operation medium is rotated while the operation medium is in proximity with the proximity operation unit 11, and the stop operation is an operation by which the operation medium is stopped while the operation medium is in proximity with the proximity operation unit 11. An example of the rotational operation is shown in FIGS. 2A and 2B. FIG. 2A is a side diagram illustrating the state in which the user U carries out the rotational operation, and FIG. 2B is a plan diagram. In the illustrated example, the operation medium is the fingertip U1 of the user U. The rotational operation is an operation causing the operation medium in proximity to the proximity operation unit 11 to rotate while the operation medium is kept in proximity with the proximity operation unit 11. The rotational operation may be either of right rotation and left rotation, and is carried out by the process according to the rotational direction, that is, the proximity process is carried out by the control unit 14.

In addition, the proximity operation unit 11 may detect a touch of the operation medium as a touch operation. When the touch operation is detected, the proximity operation unit 11 outputs touch operation information regarding contents of the touch operation to the control unit 14.

In addition, when the operation medium is moved away from the proximity operation unit 11, the proximity operation unit 11 outputs, to the control unit 14, information on a moving-away operation indicating that the operation medium is moved away from the proximity operation unit 11. In addition, the state in which the operation medium is moved away from the proximity operation unit 11, for example, means the state in which an interval between the operation medium and the proximity operation unit 11 is greater than a predetermined proximity threshold value.

Although the information processing device 10 has the proximity operation unit 11 in the present embodiment, the information processing device may not have the proximity operation unit 11. The information processing device 10 having the proximity operation unit 11, for example, includes a digital camera, a smart phone, a smart tablet, and so forth. On the other hand, the information processing device 10 not having the proximity operation unit 11, for example, includes a personal computer, and so forth. When the information processing device 10 does not have the proximity operation unit 11, the proximity operation unit 11 is mounted on or dismounted from the information processing device 10. An example of the proximity operation unit 11 includes a touch pad, and so forth.

The storage unit 13 stores information necessary for the information processing device 10 to carry out various processes, for example, stores various images, audio information, a program, and so forth. The program causes the information processing device 10 to realize functions of the control unit 14 and so forth. The presentation unit 13 displays the various images, and outputs the audio information.

The control unit 14 carries out other processes controlling each component of the information processing device 10 as follows. That is, the control unit 14 carries out the process according to the proximity operation, that is, a proximity process when the proximity operation information is given from the proximity operation unit 11. The control unit 14 carries out the process according to the touch operation, that is, a touch process when the touch operation information is given from the proximity operation unit 11. The control unit 14 cancels the proximity process when the moving-away operation information is given. It is thus possible for the user to cancel the proximity operation.

### 2. Process Sequence of Information Processing Device

Next, the process sequence of the information processing device 10 will be described with reference to the flowchart shown in FIG. 3. In addition, the information processing device 10 is assumed to be a digital camera herein. That is, images imaged by the user are stored as selection candidate images in the storage unit 12 of the information processing device 10. In addition, each of the selection candidate images is associated with a different index number for each selection candidate image. The index number is an integer, and the index number different by one digit is associated with each of the selection candidate images. In addition, the operation medium is the fingertip of the user. The control unit 14 carries out the process shown in FIG. 3 to determine (confirm) an operation target image that is a target to be read or edited by the user among the plurality of selection candidate images.

In step S10, the control unit 14 displays, on the presentation unit 13, a list image 100 in which the plurality of selection candidate images are listed and displayed as shown in FIG. 4A. In step S20, the control unit 14 determines whether the proximity operation information is given from the proximity operation unit 11. When it is determined that the proximity operation information is given from the proximity operation unit 11, the control unit 14 proceeds to step S30, and returns to step S 10 when it is determined that the proximity operation information is not given from the proximity operation unit 11. On the other hand, when the proximity operation is detected, the proximity operation unit 11 outputs the proximity operation information on contents of the proximity operation to the control unit 14. In addition, when the touch operation information is given from the proximity operation unit 11 while the list image 100 is displayed, the control unit 14 may directly proceed to the process of step S90.

In step S30, the control unit 14 determines whether the fingertip of the user stopped at the same position over a certain period of time on the basis of the proximity operation information (that is, whether the fingertip of the user is in proximity with the same selection candidate image). When it is determined that the fingertip of the user stopped at the same position over a certain period of time, the control unit 14 proceeds to step S40. Otherwise, the control unit returns to step S 10. Accordingly, the control unit 14 may run the proximity process when the fingertip of the user is detected to be within a predetermined distance, or when the fingertip of the user is detected for a predetermined period of time.

In step S40, the control unit 14 displays the selection candidate image with which the fingertip of the user is in proximity on the presentation unit 13. An example display is illustrated in FIG. 4B. In the illustrated example, the selection candidate image 101a is displayed on the presentation unit 13. In addition, the selection candidate image 101b shown in FIG. 4B has an index number greater than the selection candidate image 101a by 1, and the selection candidate image 101c has an index number smaller than the selection candidate image 101a by 1. Further, when transitioning from FIG. 4A to 4B, the apparatus may gradually focus on the selection candidate image (for example take a predetermined non-zero amount of time to transition), or the apparatus may immediately transition from FIG. 4A to 4B.

In step S50, the control unit 14 stands by until the proximity operation information, the touch operation information, or the moving-away operation information is given from the proximity operation unit 11. In step S60, the control unit 14 determines whether the proximity operation information is given from the proximity operation unit 11. The control unit 14 proceeds to step S70 when it is determined that the proximity operation information is given from the proximity operation unit 11, and proceeds to step S80 when it is determined that the moving-away operation information or the touch operation information is given from the proximity operation unit 11.

In step S70, the control unit 14 displays the selection candidate image on the presentation unit 13 in accordance with the proximity operation. This leads the control unit 14 to carry out the proximity process. In particular, for example, when the user rotates the fingertip to the right, the control unit 14 displays a selection candidate image having an index number greater than the selection candidate image being displayed by 1 on the presentation unit 13. This leads the control unit 14 to transmit the selection candidate image in the forward direction. On the other hand, when the user rotates the fingertip to the left, the control unit 14 displays a selection candidate image having an index number smaller than the selection candidate image being displayed by 1 on the presentation unit 13. This leads the control unit 14 to transmit the selection candidate image in the reverse direction.

In addition, when the user rotates the fingertip to the right while the selection candidate image having the highest index number is displayed, the control unit 14 causes the selection candidate image having the lowest index number to be displayed on the presentation unit 13. Similarly, when the user rotates the fingertip to the left while the selection candidate image having the lowest index number is displayed, the control unit 14 causes the selection candidate image having the highest index number to be displayed on the presentation unit 13. Further, even when the user carries out the rotational operation, the fingertip may return to an original position, and the user may carry out the rotational operation any number of times. Accordingly, the control unit 14 may endlessly transmit the selection candidate image. In addition, the control unit 14 may change a direction of transmitting the image when the user simply changes the rotational direction, and the control unit 14 may seamlessly change the direction of transmitting the image. In addition, the control unit 14 may carry out the image transmission on the basis of the proximity operation other than the rotational operation, for example, a translation operation causing the fingertip to move from one end of the proximity operation unit 11 to the other end of the proximity operation unit. However, in this case, the proximity operation cannot detect further translational movement beyond the end of the proximity operation unit 11, and thus it is difficult for the control unit 14 to continuously cyclically carry out the image transmission.

For example, when the user rotates the fingertip to the right while the selection candidate image 101a is displayed, the control unit 14 causes the selection candidate image 101b to be displayed on the presentation unit 13. On the other hand, when the user rotates the fingertip to the left while the selection candidate image 101a is displayed, the control unit 14 causes the selection candidate image 101c to be displayed on the presentation unit 13. When the user carries out the proximity operation other than the rotational operation, the control unit 14 continuously displays the selection candidate image being currently displayed. The control unit 14 then returns to step S50.

Accordingly, the user may carry out the proximity operation to select a selection candidate image of interest, that is, a selection candidate image that is an operation target image. In addition, in this case, even when the proximity operation is carried out, since the control unit 14 does not determine the operation target image (that is, does not immediately determine the operation target image), the user provisionally determines the selection candidate image that is the operation target image.

In addition, the control unit 14 may cancel the proximity process when the fingertip of the user is moved away from the proximity operation unit 11. In other words, the user may move the fingertip away from the proximity operation unit 11 to cancel the proximity operation. When the control unit 14 immediately determines the operation target image in response to the proximity operation, it is necessary to continuously display the operation target image even when the user moves the fingertip away from the proximity operation unit 11. A separate operation is thus necessary when the user wants to change the operation target image (i.e., when the user wants to cancel the proximity operation).

In addition, the control unit 14 may determine the number of selection candidate images transmitted for each rotational operation of one rotation on the basis of the radius of rotation of the rotational operation. That is, the control unit 14 uses the index number of the selection candidate image being currently displayed as a reference index number, and calculates the change amount of the index numbers on the basis of the magnitude of the radius of rotation. When the rotational operation is carried out to the right, the control unit 14 adds the change amount to the reference index number, calculates the new index number, and displays the selection candidate image having the calculated index number. When the rotational operation is carried out to the left, the control unit 14 subtracts the change amount from the reference index number, calculates the new index number, and displays a selection candidate image having the calculated index number. Accordingly, for example, the control unit 14 may transmit the selection candidate image for one index when the radius of rotation has a certain value, and may transmit the selection candidate images for three indexes when the radius of rotation has a value three times the certain value.

In step S80, the control unit 14 determines whether the touch operation information is given from the proximity operation unit 11. When it is determined that the touch operation information is given from the proximity operation unit 11, the control unit 14 proceeds to step S90. On the other hand, when it is determined that the moving-away operation information is given from the proximity operation unit 11, the control unit 14 returns to step S10. It is thus possible for the control unit 14 to cancel the proximity process, that is, the selection operation of the user.

In step S90, the control unit 14 carries out the touch process different from the proximity process. In particular, the control unit 14 determines (confirms) the selection candidate image touched by the fingertip of the user as the operation target image, and displays the operation target image and various editing buttons 110 on the presentation unit 13. For example, when the user touches the selection candidate image 101a displayed on the presentation unit 13, it is determined that the selection candidate image 101a is the operation target image, and the operation target image 101a and the editing buttons 110 are displayed on the presentation unit 13 as shown in FIG. 4C. The user may use the editing buttons 110 to edit the operation target image. The information processing device 10 then finishes the process shown in FIG. 3.

As described above, according to the present embodiment, the information processing device 10 carries out the proximity process based on the proximity operation when the proximity operation unit 11 detects the proximity operation, and cancels the proximity process when the operation medium is moved away from the proximity operation unit 11. Accordingly, it is possible for the user to cancel the proximity operation by moving the operation medium, for example, the fingertip of the user, away from the proximity operation unit 11, and it is thus possible for the user to readily cancel the operation of the user. That is, it is possible for the user to readily carry out the cancellation operation.

Further, it is possible for the information processing device 10 to cause the presentation unit 13 to display the selection candidate image in accordance with the proximity operation, and thus the user may cause the information processing device 10 to readily display the selection candidate image of interest and may readily cancel selection of the selection candidate image.

Further, the information processing device 10 displays the list image 100 on the presentation unit 13 until the operation medium is brought into proximity with the proximity operation unit 11, and displays the selection candidate information according to the proximity operation when the proximity operation is carried out. It is thus possible for the user to first confirm the list of the selection candidate images and then to cause the information processing device 10 to display the selection candidate image of interest.

In addition, when the operation medium is moved away from the proximity operation unit 11, the information processing device 10 may readily cancel the proximity process by displaying the list image 100 on the presentation unit 13 and canceling the proximity process. In addition, the user may readily ascertain that the proximity process is canceled.

In addition, when the operation medium touches the proximity operation unit 11, the information processing device 10 may carry out the touch process different from the proximity process, and thus the user may cause the information processing device 10 to carry out the touch process merely by touching the proximity operation unit 11 with the operation medium. In particular, the information processing device 10 may determine the selection candidate image touched by the operation medium as the operation target image, and thus the user may readily determine the operation target image.

Further, the user may carry out provisional determination, determination, and cancellation on the operation target image merely by carrying out the series of operations such as the proximity operation, the touch operation, and the moving-away operation (an operation causing the operation medium to be moved away from the proximity operation unit 11). Accordingly, the user may readily carry out the provisional determination, determination, and cancellation on the operation target image. In addition, although the information processing device 10 displays the selection candidate image as the selection candidate information, various character information may also be displayed as the selection candidate image.

### 3. First Modification Example

Next, the first modification example will be described. The modification example causes the information processing device 10 to carry out a retouch process. In addition, as shown in FIG. 5A, the control unit 14 transitions to a normal mode by displaying the reference image 200 and various editing buttons 210 on the presentation unit 13. These editing buttons 210 include brightness adjustment buttons for adjusting the brightness of the reference image 200.

When the fingertip U1 of the user touches (or is in proximity with) the brightness adjustment button, the control unit 14 transitions to the brightness adjustment mode. When it is not the brightness adjustment mode, the control unit 14 may adjust the reference image 200 on the basis of the rotational operation from the user. This leads the control unit 14 to carry out the proximity process.

In particular, as shown in FIG. 5B, the control unit 14 displays the adjusted image of which the brightness of the reference image 200 is increased by the amount according to the number of rotations when the rotational operation is carried out to the right, and displays the adjusted image of which the brightness of the reference image 200 is decreased by the amount according to the number of rotations when the rotational operation is carried out to the left. In addition, in this case, the adjustment amount of the brightness is not definite.

Next, when the fingertip U1 of the user touches the proximity operation unit 11, the control unit 14 returns to the normal mode by confirming and displaying the adjusted image as the new reference image 200. This leads the control unit 14 to carry out the touch process. On the other hand, when the fingertip U1 of the user is moved away from the proximity operation unit 11, the control unit 14 cancels the proximity process, that is, the brightness adjustment, and displays the original reference image 200. This leads the control unit 14 to return to the normal mode.

In addition, the control unit 14 may adjust the brightness of the reference image 200 on the basis of other proximity operations, for example, an operation causing the fingertip to move from one end of the proximity operation unit 11 to the other end. For example, the control unit 14 may adjust the brightness of the reference image 200 in accordance with up and down directions of the fingertip U1 as shown in FIG. 6. As described above, in the operation causing the fingertip to move from one end of the proximity operation unit 11 to the other end, the proximity operation is finished at the end of the proximity operation unit 11. However, the brightness value also has certain upper limit and lower limit values. Accordingly, even when the brightness of the reference image 200 is adjusted on the basis of the proximity operation, the control unit 14 may exactly correct the brightness of the reference image 200. In addition, the information processing device 10 may adjust not only the brightness but also other parameters such as saturation of color.

Accordingly, in the first modification example, the information processing device 10 adjusts the reference image 200 on the basis of the proximity operation to generate an adjusted image, and displays the adjusted image on the presentation unit 13. It is thus possible for the user to, for example, cancel the adjustment on the reference image 200 by moving the fingertip of the user away from the proximity operation unit 11.

### 4. Second Modification Example

Next, the second modification example will be described. The second modification example causes the information processing device 10 to adjust the volume while audio information is output. In addition, the control unit 14 outputs the reference audio information that is a volume adjustment target. Further, the control unit 14 displays the audio output image 300 indicating that the reference audio information is being output and various editing buttons 310 as shown in FIG. 7A. This leads the control unit 14 to transition to the normal mode. These editing buttons 310 include a volume adjustment button for adjusting the volume of the audio information.

The control unit 14 transitions to the volume adjustment mode when the fingertip U1 of the user touches (or is in proximity with) the volume adjustment button. The control unit 14 may adjust the volume of the reference audio information on the basis of the rotational operation from the user in the volume adjustment mode. This leads the control unit 14 to carry out the proximity process.

In particular, as shown in FIG. 7B, when the rotational operation is carried out to the right, the control unit 14 generates and outputs adjusted audio information in which the volume of the reference audio information is increased by the volume according to the number of rotations. On the other hand, when the rotational operation is carried out to the left, the control unit 14 generates and outputs adjusted audio information in which the volume of the reference audio information is decreased by the volume according to the number of rotations. In addition, in this case, the adjustment amount of the volume is not definite.

Next, when the fingertip U1 of the user touches the proximity operation unit 11, the control unit 14 confirms and outputs the adjusted audio information as the new reference audio information, and returns to the normal mode. This leads the control unit 14 to carry out the touch process. On the other hand, when the fingertip U1 of the user is moved away from the proximity operation unit 11, the control unit 14 cancels the proximity process, that is, cancels the volume adjustment, and outputs the original reference audio information. This leads the control unit 14 to return to the normal mode. In addition, the control unit 14 may adjust the volume of the reference audio information on the basis of other proximity operations, for example, an operation causing the fingertip to move from one end of the proximity operation unit 11 to the other end of the proximity operation unit. The reason is the same as in the first modification example.

Accordingly, in the second modification example, the information processing device 10 adjusts the reference audio information on the basis of the proximity operation to generate and output the adjusted audio information. It is thus possible for the user to, for example, cancel the adjustment on the reference audio information merely by moving the fingertip of the user away from the proximity operation unit 11.

While the preferred embodiments of the present disclosure have been particularly described with reference to accompanying drawings, the technical scope of the present disclosure is not limited thereto. It will be understood by those of ordinary skill in the art that various changes or modifications which are also encompassed within the technical scope of the present disclosure are possible within the technical spirit as defined by the following claims. For example, the information processing device 10 may carry out an image generation process. In this case, the information processing device 10 may enlarge or reduce the stamp image on the basis of the rotational operation of the user. In addition, the information processing device 10 may confirm the size of each stamp image when the user touches the stamp image, and may cancel adjustment on the stamp image and make the size of the stamp image return to the original size when the user moves the fingertip away from the proximity operation unit 11.

Additionally, the present technology may also be configured as below.

(1) An apparatus including:
a proximity detection information receiving unit configured to receive an indication that an object is in proximity with or touching a surface; and
a controller configured to
perform a proximity process when the object is in proximity with the surface,
end the proximity process when the object is no longer in proximity with the surface, and
perform a touch process different than the proximity process when the object is touching the surface.

(2) The apparatus according to (1), wherein the controller ends the proximity process when the object touches the surface.

(3) The apparatus according to (2), wherein the controller cancels the proximity process when the controller ends the proximity process.

(4) The apparatus according to (3), wherein the controller returns the apparatus to an initial state when the controller cancels the proximity process.

(5) The apparatus according to (1) to (4), wherein the controller controls a display to display a plurality of pictures in an initial state.

(6) The apparatus according to (5), wherein the controller controls the display to focus in on one of the plurality of pictures as the proximity process.

(7) The apparatus according to (6), wherein the controller controls the display to gradually focus in on the one of the plurality of pictures as the proximity process.

(8) The apparatus according to (7), wherein the controller scrolls through the plurality of images one image at a time based on a rotational movement of the object during the proximity process.

(9) The apparatus according to (7), wherein the controller scrolls through the plurality of images one image at a time based on a translational movement of the object during the proximity process.

(10) The apparatus according to (6), wherein the controller controls the display to display a plurality of menu items as the touch process.

(11) The apparatus according to (10), wherein the controller controls the display to display the plurality of menu items superimposed over display of the one of the plurality of pictures.

(12) The apparatus according to (1) to (11), wherein the controller controls a characteristic of an image as the proximity process.

(13) The apparatus according to (12), wherein the controller controls a brightness of an image as the proximity process based on a rotational movement of the object.

(14) The apparatus according to (12), wherein the controller fixes a current value of the characteristic of the image as the touch process.

(15) The apparatus according to (1) to (14), wherein the controller controls a characteristic of a sound output as the proximity process.

(16) The apparatus according to (15), wherein the controller controls a volume of the sound output as the proximity process based on a rotational movement of the object.

(17) The apparatus according to (1) to (16), wherein the controller performs the proximity process when the object is within a predetermined distance of the surface.

(18) The apparatus according to (1) to (16), wherein the controller performs the proximity process when the proximity detection information receiving unit receives the indication that the object is in proximity with the surface for a predetermined period of time.

(19) A method including:
receiving an indication that an object is in proximity with or touching a surface;
performing a proximity process when the object is in proximity with the surface;
ending the proximity process when the object is no longer in proximity with the surface; and
performing a touch process different than the proximity process when the object is touching the surface.

(20) A non-transitory computer readable medium encoded with a program that, when loaded on a processor, causes the processor to perform a method including:
receiving an indication that an object is in proximity with or touching a surface;
performing a proximity process when the object is in proximity with the surface;
ending the proximity process when the object is no longer in proximity with the surface; and
performing a touch process different than the proximity process when the object is touching the surface.

### REFERENCE SIGNS LIST

10 Information processing device

11 Proximity operation unit

12 Storage unit

13 Presentation unit

1. An apparatus comprising:
a proximity detection information receiving unit configured to receive an indication that an object is in proximity with or touching a surface; and
a controller configured to
perform a proximity process when the object is in proximity with the surface,
end the proximity process when the object is no longer in proximity with the surface, and
perform a touch process different than the proximity process when the object is touching the surface.

2. The apparatus according to claim 1, wherein the controller ends the proximity process when the object touches the surface.

3. The apparatus according to claim 2, wherein the controller cancels the proximity process when the controller ends the proximity process.

4. The apparatus according to claim 3, wherein the controller returns the apparatus to an initial state when the controller cancels the proximity process.

5. The apparatus according to claim 1, wherein the controller controls a display to display a plurality of pictures in an initial state.

6. The apparatus according to claim 5, wherein the controller controls the display to focus in on one of the plurality of pictures as the proximity process.

7. The apparatus according to claim 6, wherein the controller controls the display to gradually focus in on the one of the plurality of pictures as the proximity process.

8. The apparatus according to claim 7, wherein the controller scrolls through the plurality of images one image at a time based on a rotational movement of the object during the proximity process.

9. The apparatus according to claim 7, wherein the controller scrolls through the plurality of images one image at a time based on a translational movement of the object during the proximity process.

10. The apparatus according to claim 6, wherein the controller controls the display to display a plurality of menu items as the touch process.

11. The apparatus according to claim 10, wherein the controller controls the display to display the plurality of menu items superimposed over display of the one of the plurality of pictures.

12. The apparatus according to claim 1, wherein the controller controls a characteristic of an image as the proximity process.

13. The apparatus according to claim 12, wherein the controller controls a brightness of an image as the proximity process based on a rotational movement of the object.

14. The apparatus according to claim 12, wherein the controller fixes a current value of the characteristic of the image as the touch process.

15. The apparatus according to claim 1, wherein the controller controls a characteristic of a sound output as the proximity process.

16. The apparatus according to claim 15, wherein the controller controls a volume of the sound output as the proximity process based on a rotational movement of the object.

17. The apparatus according to claim 1, wherein the controller performs the proximity process when the object is within a predetermined distance of the surface.

18. The apparatus according to claim 1, wherein the controller performs the proximity process when the proximity detection information receiving unit receives the indication that the object is in proximity with the surface for a predetermined period of time.

19. A method comprising:
receiving an indication that an object is in proximity with or touching a surface;
performing a proximity process when the object is in proximity with the surface;
ending the proximity process when the object is no longer in proximity with the surface; and
performing a touch process different than the proximity process when the object is touching the surface.

20. A non-transitory computer readable medium encoded with a program that, when loaded on a processor, causes the processor to perform a method comprising:
receiving an indication that an object is in proximity with or touching a surface;
performing a proximity process when the object is in proximity with the surface;
ending the proximity process when the object is no longer in proximity with the surface; and
performing a touch process different than the proximity process when the object is touching the surface.
